(19) United States
(12) Patent Application Publication
(10) Pub. No.: US 2006/0255183 A1
(43) Pub. Date: Nov. 16, 2006

(54) Extension pole apparatus

(75) Inventors: Thomas A. Burdsall, Nashville, TN (US); Lance S. Lindenberg, Hermitage, TN (US)

Correspondence Address: STEPHEN D. SCANLON, JONES DAY, 901 LAKESIDE AVENUE, CLEVELAND, OH, 44114, US

(73) Assignees: Thomas A. Burdsall; Lance S. Lindenberg

(21) Appl. No.: 11/166,517

(22) Filed: Jun. 24, 2005

Related U.S. Application Data
(60) Provisional application No. 60/676,900, filed on May 2, 2005.

(51) Int. Cl. B05B 9/01

(52) U.S. Cl. 239/526; 239/525; 239/532

(57) ABSTRACT

An apparatus includes an extension pole, a hydraulic valve, and a handle containing the valve. The handle has a forward end portion configured to receive the extension pole in an installed position. The handle also has a pistol grip portion inclined from the forward end portion. A valve trigger is supported on the handle. The valve trigger has a pistol grip section that extends along the pistol grip portion of the handle within reach of a user's hand grasping the pistol grip portion from behind. The valve trigger further has an upper grip section that projects forward beneath the installed position of the extension pole within reach of a user's hand grasping the extension pole from above.

### RELATED APPLICATIONS

This application claims the benefit of provisional U.S. Patent application No. 60/676,900, filed May 2, 2005, entitled High Pressure Extension Pole, which is incorporated by reference.

### TECHNICAL FIELD

This technology relates to an extension pole for a water hose.

### BACKGROUND

A person using a water hose, such as a garden hose or a pressure washer hose, may need to extend the reach of the hose beyond the arm's length reach of the user. An extension pole can be used for this purpose. The extension pole may be equipped with a handle containing a valve that directs water from the source hose into an extension hose that extends through the pole. The valve is actuated by a trigger on the handle.

### SUMMARY

An apparatus includes an extension pole, a hydraulic valve, and a handle containing the valve. The handle has a forward end portion configured to receive the extension pole in an installed position. The handle also has a pistol grip portion inclined from the forward end portion. A valve trigger is supported on the handle. The valve trigger has a pistol grip section that extends along the pistol grip portion of the handle. That section of the trigger is within reach of a user's hand grasping the pistol grip portion of the handle from behind. The valve trigger further has an upper grip section that projects forward beneath the installed position of the extension pole. That section of the trigger is within reach of a user's hand grasping the extension pole from above.

Summarized differently, an apparatus includes a tubular extension pole, a hydraulic valve having an output fitting, and an extension hose configured to extend in a loop of variable length from the output fitting into the extension pole. The apparatus further includes a handle containing the valve. The handle has a) a forward end portion configured to receive the extension pole in an installed position, b) a rear end portion with an opening, and c) an internal passage configured for the loop to extend into the passage through the opening, through the passage, and into the extension pole through the forward end portion of the handle.

In view of other features, the apparatus can be summarized as including a tubular extension pole having a longitudinal axis, a hose receivable through the pole, and a nozzle structure on the end of the hose. The apparatus further includes a collar that is configured to mate with the nozzle structure to block movement of the nozzle structure axially relative to the collar. A detent mechanism is operative between the collar and the pole. Preferably, another detent mechanism is operative between the pole and the handle.

### BRIEF DESCRIPTION OF THE DRAWINGS

FIG. 1 is a perspective view of a pressure washing device including an extension pole, a hose and a handle.

FIG. 2 is an enlarged view of parts shown in FIG. 1.

FIG. 3 is a side view of the parts shown in FIG. 2.

FIG. 4 is an exploded view of parts shown in FIGS. 2 and 3.

FIG. 5 is a perspective view of a part shown in FIG. 4.

FIG. 6 is an exploded view of other parts shown in FIG. 1.

FIG. 7 is a side view of parts shown in FIG. 1.

### DETAILED DESCRIPTION

The apparatus 10 shown in the drawings has parts that are examples of the structural elements recited in the claims. The illustrated apparatus 10 thus includes examples of how a person of ordinary skill in the art can make and use the claimed invention. It is described here to meet the enablement and best mode requirements of the patent statute without imposing limitations that are not recited in the claims.

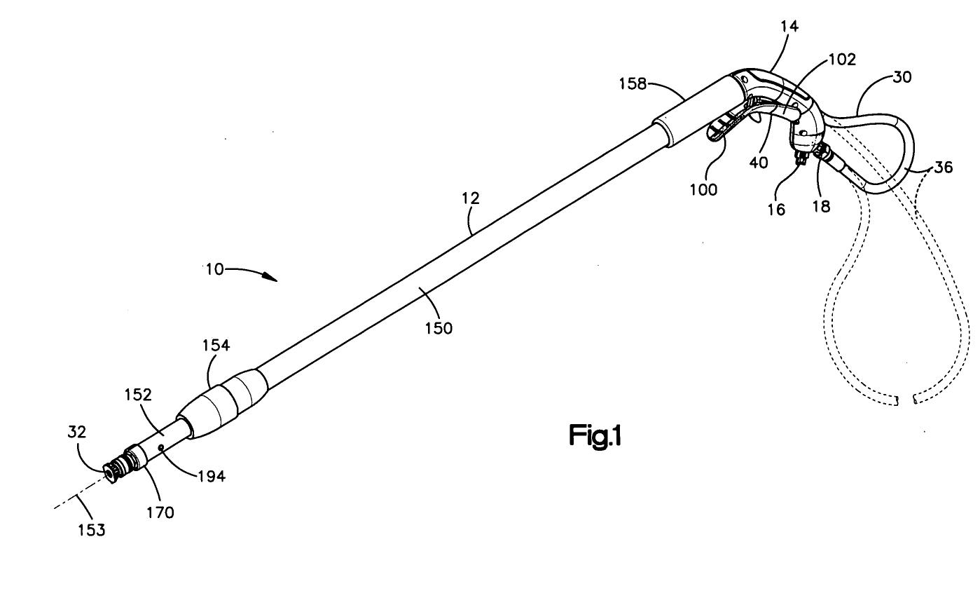

The illustrated apparatus 10 is a pressure washing device including a telescopic extension pole 12 and a handle 14. The handle 14 contains a hydraulic valve with input and output couplings 16 and 18. The input coupling 16 is configured to receive the output hose of a pressure washer (not shown). An extension hose 30 extends from the output coupling 18 to a nozzle assembly 32 at the outer end of the pole 12. As indicated in the broken line view in FIG. 1, a section of the hose 30 extends in a loop 36 that varies in length upon extension and retraction of the pole 12. A trigger 40 on the handle 14 enables the user to actuate the valve as desired to open a flow path through the device 10 from the input fitting 16 to the nozzle assembly 32.

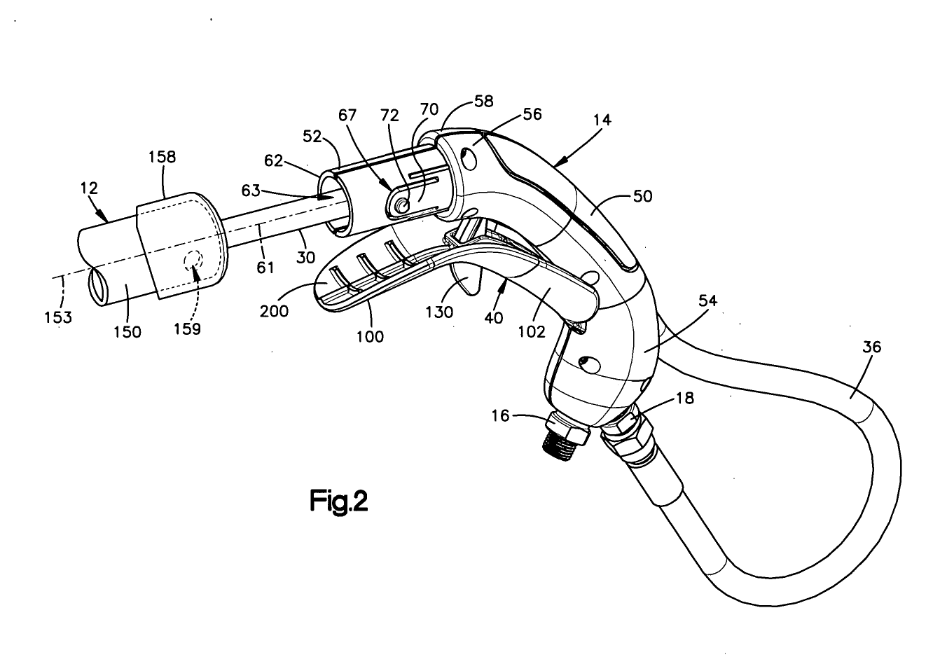

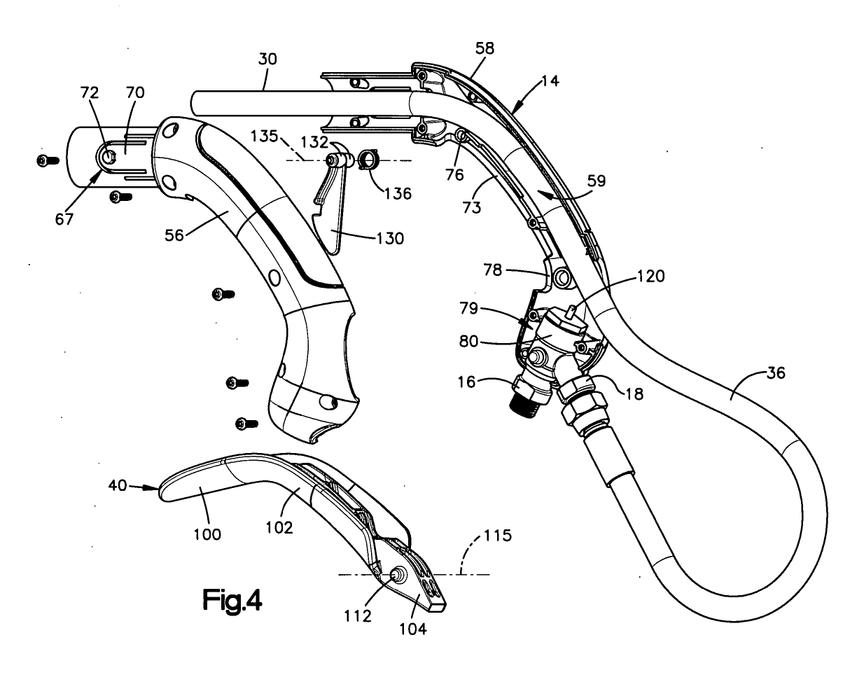

As shown in FIGS. 2-4, the handle 14 is elongated with a major length portion 50 configured as a pistol grip. The pistol grip portion 50 of the handle 14 extends rearward and downward from a forward end portion 52 to a lower end portion 54. As shown in the exploded view of FIG. 4, the handle 14 is defined by a pair of opposed halves 56 and 58. Each half 56 and 58 extends along the entire length of the handle 14 such that the two halves 56 and 58 together define all three portions 50, 52 and 54 of the handle 14 when they are fastened together. The assembled handle 14 is a hollow structure with a longitudinally extending passage 59 (FIG. 4) for the hose 30.

The forward end portion 52 of the handle 14 is a cylindrical tube with a longitudinal central axis 61. A circular edge surface 62 defines an opening 63 for the hose 30. A pair of U-shaped slots 67 on the forward end portion 52 have diametrically opposed locations. Each slot 67 defines a radially deflectable locking tab 70. A respective detent member 72 projects radially outward near the forward end of each locking tab 70.

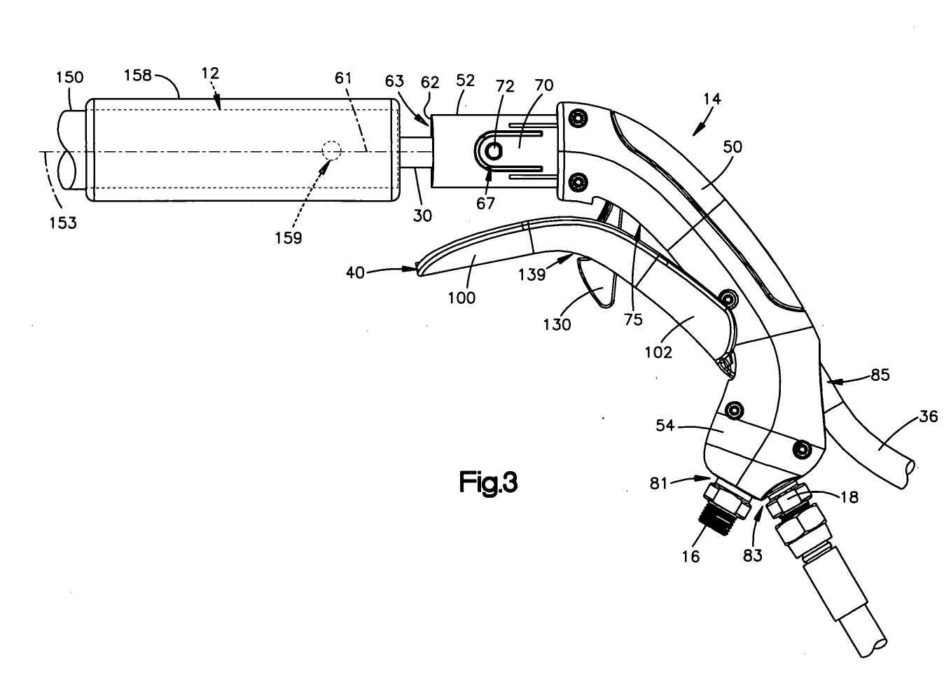

The peripheral configuration of the pistol grip 50 is generally circular and uniform along its length between the forward end portion 52 and the lower end portion 54. The two halves 56 and 58 of the handle 14 have a pair of opposed edge surfaces 73, one of which is shown in FIG. 4. Those edge surfaces 73 together define a slot 75 (FIG. 3) in the pistol grip 50 when the two halves 56 and 58 are fastened together. A pair of opposed counterbore structures 76, one of which also is shown in FIG. 4, are located within the two halves 56 and 58 near the upper end of the slot 75. Another pair of opposed counterbore structures 78 are similarly located near the lower end of the slot 75.

The lower end portion 54 of the handle 14 has a slight radial bulge. The wider configuration of the lower end portion 54 is an ergonomic structural feature that helps to distinguish it from the pistol grip 50, and also provides a chamber 79 for containing the valve 80 (FIG. 4). Like the slot 75 in the pistol grip 50, several additional openings 81, 83 and 85 (FIG. 3) in the lower end portion 54 are defined by opposed edge surfaces of the two halves 56 and 58 of the handle 14. These include a lower opening 81 through which the input coupling 16 projects from the valve 80, another lower opening 83 through which the output coupling 18 projects from the valve 80, and a rear opening 85 for the hose 30.

As noted above, a section of the hose 30 extends in a loop 36. More specifically, the loop 36 begins at the output coupling 18 on the valve 80, and extends into the rear opening 85 in the lower end portion 54 of the handle 14. The loop 36 extends further through the passage 59 in the handle 14, and from the handle 14 into the pole 12 through the opening 63 at the forward end portion 52 of the handle 14. Since the hose is fixed to the nozzle assembly 32 at the outer end of the pole 12, the length of the loop 36 between the output coupling 18 and the opening 63 is increased upon retraction of the pole 12, and is decreased upon extension of the pole 12.

The trigger 40 is an elongated structure with an upper grip section 100, a pistol grip section 102, and a base 104. As shown in FIG. 5, an inner edge surface 106 of the trigger 40 defines a slot 109 in the pistol grip section 102. A pair of stub shafts 112 project from opposite sides of the base 104 along a pivotal axis 115. The stub shafts 106 are received within the lower counterbore structures 78 on the handle 14 to support the trigger 40 for movement pivotally about the axis 115.

The trigger 40 has an unactuated position, as shown in FIGS. 2 and 3. An actuator pin 120 on the valve 80 (FIG. 4) projects upward into engagement with the base portion 104 of the trigger 40. Accordingly, when the trigger 40 is moved from the unactuated position in a clockwise direction, as viewed in the drawings, the base portion 104 of the trigger 40 pushes the actuator pin 120 inward of the valve 80. This shifts the valve 80 into and through a range of increasingly open conditions. A return spring in the valve 80 urges the actuator pin 120 back outward toward the original position in which the valve 80 is closed and the trigger 40 is located in the unactuated position.

A spring-loaded safety latch 130 ordinarily retains the trigger 40 in the unactuated position. A pair of stub-shafts 132 (FIG. 4) on the latch 130 are received in the upper counterbore structures 76 on the handle 14 to support the latch 130 for movement pivotally about an axis 135 parallel to the axis 115, with the latch 130 projecting downward through the slot 109 in the trigger 40. A spring 136 acts between the handle 14 and the latch 130 to urge it into a locking position in which a notch 139 on the latch 130 is received over an edge portion 140 (FIG. 5) of the trigger 40 beside the slot 109.

The illustrated example of an extension pole 12 is a tubular cylindrical structure with first and second sections 150 and 152 centered on a longitudinal axis 153. The extension pole 12 further has a screw-threaded fitting 154 which, as known in the art, can be loosened to permit movement of the second section 152 telescopically within the first section 150, and tightened to retain the second section 152 in a selected position for a selected length of the pole 12. A compressible foam hand grip 158 is received over the first section 150 of the pole 12.

The pole 12 is installed on the handle 14 by sliding the first section 150 of the pole 12 coaxially over the forward end portion 52 of the handle 14 until the detent members 72 on the handle 14 snap into a corresponding pair of apertures 159 in the pole 12. The user can slide the hand grip 158 forward over the first section 150 of the pole 12 as needed to access the detent members 72.

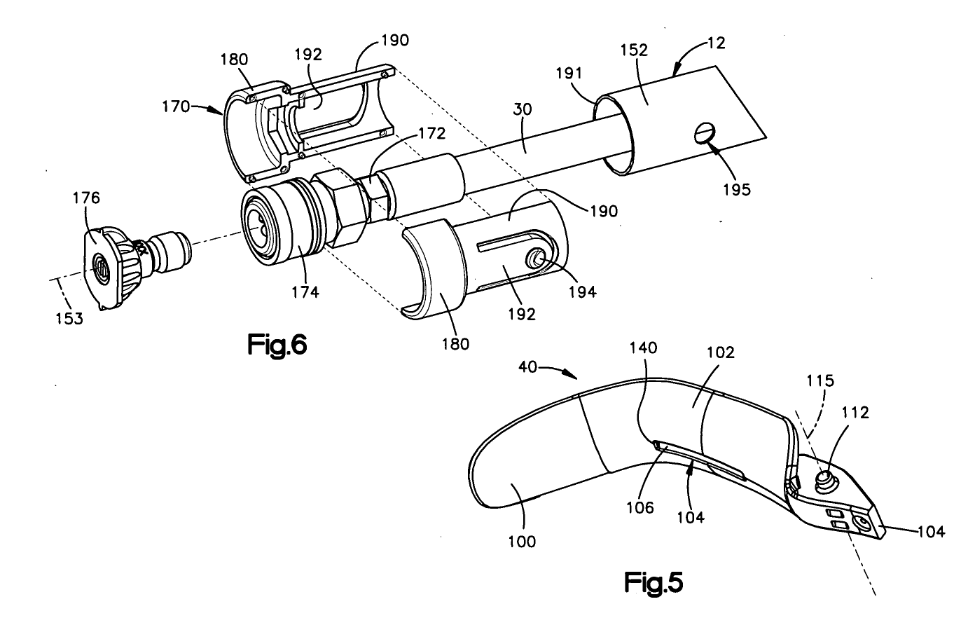

A collar 170 (FIG. 1) attaches the hose 30 to the outer end of the second pole section 152. As shown in enlarged detail in FIG. 6, the hose 30 has a nozzle fitting 172. The nozzle assembly 32 includes a quick-connect receptacle 174 that is mounted on the nozzle fitting 172. The nozzle assembly 32 further includes a plurality of interchangeable nozzle tips 176, one of which is shown as an example in FIG. 6. The collar 170 is an elongated cylindrical structure with two opposed halves 180 that are receivable coaxially over the nozzle fitting 172. Inner surfaces of the collar halves 180 are configured to mate with corresponding outer surfaces of the fitting 172 to block movement of the collar 170 and the fitting 172 axially relative to each other. Rear sections 190 of the collar halves 180 are receivable together within the open end 191 of the second hose section 152. The rear sections 190 of the collar halves 180 have flexible locking tabs 192 with detent members 194 that are receivable through a corresponding pair of apertures 195 in the second hose section 152.

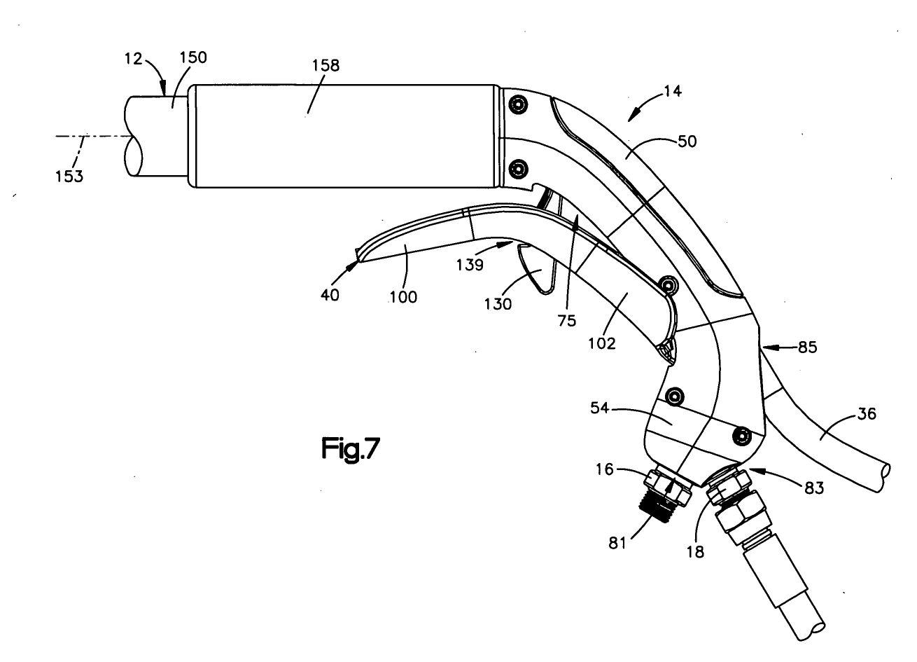

With the device 10 assembled as shown in FIG. 1, the user can actuate the valve 80 by grasping and pivoting the trigger 40 from either of two different hand positions. The first hand position is on the pistol grip portion 50 of the handle 14. As best shown in the side view of FIG. 7, the pistol grip section 102 of the trigger 40 is within reach of a user's hand grasping the pistol grip portion 50 of the handle 14 from behind. The second hand position is on the extension pole 12 where the pole 12 overlies the front end portion 50 of the handle 14. As best shown in the side view of FIG. 3, the upper grip section 100 of the trigger 40 projects forward beneath and beyond the forward end portion 52 of the handle 14. Accordingly, as shown in FIG. 7, the upper grip section 100 of the trigger 40 projects forward beneath the installed position of the pole 12 to be within reach of a user's hand grasping the hand grip 158 (or the pole 12 without the handgrip 158) from above. A concave upper surface 200 (FIG. 2) of the trigger 40 has a generally cylindrical contour for the upper section 100 of the trigger 40 to mate with the hand grip 158 when the trigger 40 is fully actuated.

This written description sets forth the best mode of carrying out the invention, and describes the invention so as to enable a person skilled in the art to make and use the invention, by presenting examples of the elements recited in the claims. The patentable scope of the invention is defined by the claims, and may include other examples that occur to those skilled in the art. Such other examples, which may be available either before or after the application filing date, are intended to be within the scope of the claims if they have elements that do not differ from the literal language of the claims, or if they have equivalent elements with insubstantial differences from the literal language of the claims.

1. An apparatus comprising:
an extension pole;
a hydraulic valve;
a handle containing said valve, said handle having a forward end portion configured to receive said extension pole in an installed position, and having a pistol grip portion inclined from said forward end portion; and
a valve trigger supported on said handle, said valve trigger having a pistol grip section that extends along said pistol grip portion of said handle within reach of a user's hand grasping said pistol grip portion from behind, and further having an upper grip section that projects forward beneath said installed position of said extension pole within reach of a user's hand grasping said extension pole from above.

2. An apparatus as defined in claim 1 wherein said upper grip section of said valve trigger projects forward beyond said forward end portion of said handle.

3. An apparatus as defined in claim 1 wherein said extension pole has a portion configured as a hand grip.

4. An apparatus as defined in claim 3 wherein said upper grip section of said valve trigger projects forward beneath the installed position of said hand grip.

5. An apparatus as defined in claim 4 wherein said upper grip section of said valve trigger is configured to mate with said hand grip when said valve trigger is in an actuated position.

6. An apparatus as defined in claim 5 wherein said upper grip section of said valve trigger has a concave upper surface with a generally cylindrical contour.

7. An apparatus as defined in claim 1 wherein said extension pole is telescopic.

8. An apparatus comprising:
a tubular extension pole;
a hydraulic valve having an output fitting;
an extension hose configured to extend in a loop of variable length from said output fitting into said extension pole; and
a handle containing said valve, said handle having a) a forward end portion configured to receive said extension pole in an installed position, b) a rear end portion with an opening, and c) an internal passage configured for said loop to extend into said passage through said opening, through said passage, and into said extension pole through said forward end portion of said handle.

9. An apparatus as defined in claim 8 wherein said handle has a pistol grip portion inclined from said forward end portion, and has a lower end portion with an opening through which said output fitting protrudes from said handle.

10. An apparatus as defined in claim 8 wherein said extension pole is telescopic.

11. An apparatus comprising:
an tubular extension pole having a longitudinal axis;
a hose receivable through said pole;
a nozzle structure on the end of said hose;
a collar configured to mate with said nozzle structure to block movement of said nozzle structure axially relative to said collar; and
a detent mechanism operative between said collar and said pole.

12. An apparatus as defined in claim 11 wherein said detent mechanism is defined by said collar and said pole.

13. An apparatus as defined in claim 12 wherein said collar comprises an elongated cylindrical structure with two opposed halves that are receivable coaxially over said nozzle structure, and each of said opposed halves of said collar has a flexible locking tab with a radially projecting detent member receivable through an aperture in said pole.

14. An apparatus comprising:
an extension pole;
a hydraulic valve;
a handle containing said valve, said handle having a portion configured to receive said extension pole in an installed position; and
a detent mechanism operative between said pole and said portion of said handle.

15. An apparatus as defined in claim 14 wherein said detent mechanism is defined by said pole and said portion of said handle.

16. An apparatus as defined in claim 15 wherein said portion of said handle is a tubular structure over which said pole is receivable in said installed position, and said tubular structure has opposed halves, each of which has a flexible locking tab with a detent member receivable through an aperture in said pole.
